(19) United States
(12) Patent Application Publication
(10) Pub. No.: US 2020/0318447 A1
(43) Pub. Date: Oct. 8, 2020

(54) AUTOMATION OF SURFACE BACKPRESSURE USING FULL DRILLING SYSTEM PARAMETERS FOR PRESSURE CONTROL IN DOWNHOLE ENVIRONMENTS

(71) Applicant: Saudi Arabian Oil Company, Dhahran (SA)

(72) Inventors: Mohammad Aljubran, Dammam (SA); Abdullah Saleh Hussain Al-Yami, Dhahran (SA); Salem H. Al Gharbi, Dammam (SA)

(73) Assignee: Saudi Arabian Oil Company, Dhahran (SA)

(21) Appl. No.: 16/373,020

(22) Filed: Apr. 2, 2019

(51) Int. Cl. E21B 21/08; E21B 47/06; E21B 21/10; G06F 17/50; G06F 16/23

(52) U.S. Cl. CPC E21B 21/08; E21B 47/06; G06F 16/2365; G06F 17/5009; E21B 21/106

(57) ABSTRACT

The disclosure generally describes methods, software, and systems for automating parameters used in drilling operations. A computer-implemented method includes the following steps. Real-time information associated with fluid density, drilling operational parameters, and rheology is received from devices installed on site and downhole at a managed pressure drilling (MPD) operation. The real-time information is processed to ensure accuracy of the real-time information, and the real-time information is stored in a database. Real-time measurements of equivalent circulating density (ECD) are determined from the stored real-time information using modeling techniques. Hydraulic calculations are performed to determine annular pressure losses (APL). Surface backpressure (SBP) is determined in real time based on the APL. The MPD operation is automatically updated based on the determined SBP.

### BACKGROUND

The present disclosure applies to automating processes for drilling wells, such as oil wells. Underbalanced drilling (UBD) is a technique in which the gross bottomhole pressure is less than the formation pressure. This inequality in pressures can allow formation fluid to flow into the wellbore continuously, including throughout the drilling operation. The presence of formation fluid can adversely affect drilling operations. For example, the presence of formation fluid can complicate the ability to maintain a bottomhole pressure between the fracture pressure and the pore pressure. In ideal drilling operations, managed pressure drilling (MPD) can be used to accurately control the annular pressure while drilling, cementing, and completing wells. MPD techniques can help to maintain the bottomhole pressure between the fracture pressure and pore pressure.

### SUMMARY

The present disclosure describes techniques that can be used for automatically determining surface backpressure (SBP). SBP parameters can be used in constant bottomhole pressure applications where surface backpressure is used to improve drilling operations. Surface backpressures can be automated using real-time inflow data streams.

In some implementations, a computer-implemented method includes the following steps. Real-time information associated with fluid density, drilling operational parameters, and rheology is received from devices installed on site and downhole at a managed pressure drilling (MPD) operation. The real-time information is processed to ensure accuracy of the real-time information, and the real-time information is stored in a database. Real-time measurements of equivalent circulating density (ECD) are determined from the stored real-time information using modeling techniques. Hydraulic calculations are performed to determine annular pressure losses (APL). Surface backpressure (SBP) is determined in real time based on the APL. The MPD operation is automatically updated based on the determined SBP.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. First, managed pressure drilling (MPD), which includes accurately controlling the annular pressure while drilling, cementing, and completing wells, can help to maintain the bottomhole pressure between the fracture pressure and the pore pressure. Second, accurate, real-time SBP calculations can be made, which can be beneficial to drilling engineering and operations. Third, real-time SBP calculations can replace non-automated estimations made in the field. For example, non-automated estimates are conventionally used due to a lack of automated hydraulics calculations that can eventually lead to severe well control and lost circulation scenarios. Fourth, real-time calculations of pressure loss and SBP can be provided to rig operators and offices to ensure smooth drilling operations by using real-time fluid properties measured at frequent rates.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a graph showing examples of relationships between mud density and true vertical depth for different drilling techniques, according to some implementations of the present disclosure.

FIG. 2 is a bar chart showing examples of differences between pressures attained in conventional drilling versus managed pressure drilling, according to some implementations of the present disclosure.

FIGS. 3A-3B include graphs showing examples of output of an algorithm that automates surface backpressure (SBP) based on an actual equivalent circulating density (ECD) and a desired bottomhole pressure, according to some implementations of the present disclosure.

FIG. 4 is a flowchart of an example method for updating managed pressure drilling (MPD) operations based on real-time values determined for SBP, according to some implementations of the present disclosure.

FIG. 5 is a block diagram illustrating an example computer system used to provide computational functionalities associated with described algorithms, methods, functions, processes, flows, and procedures as described in the instant disclosure, according to some implementations of the present disclosure.

Like reference numbers and designations in the various drawings indicate like elements.

### DETAILED DESCRIPTION

The following detailed description describes techniques for automating parameters used in drilling operations. For example, surface backpressure (SBP) can be automatically determined and used with constant bottomhole pressure applications where surface backpressure is regulated. Surface backpressure can be automated using real-time inflow data stream and real-time mud property surface measurement, downhole measurements, and information about wellbore fluid hydraulics. Real-time calculations of pressure loss and SBP can be provided to rig operators and offices to ensure smooth drilling operations by using real-time fluid properties measured at frequent rates.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and to the extent that such details are within the skill of one of ordinary skill in the art. The present disclosure is not intended to be limited to the described or illustrated implementations, but to be accorded the widest scope consistent with the described principles and features.

In some implementations, application code can be used to automate some of the parameters and actions for automating surface backpressure. Algorithms and application code that are developed can use real-time calculations. Algorithms and application code can connect to (and use real-time information from) a drilling company's databases. Test data can be developed to validate the algorithms and application code.

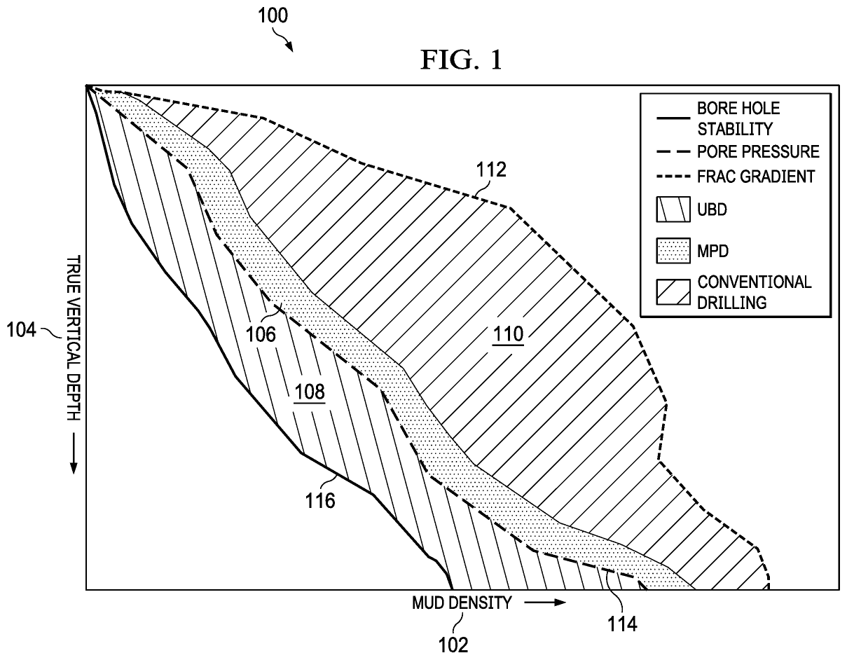

FIG. 1 is a graph showing examples of relationships 100 between mud density 102 and true vertical depth 104 for different drilling techniques, according to some implementations of the present disclosure. For example, FIG. 1 depicts comparisons between managed pressure drilling (MPD) 106 and underbalanced drilling (UBD) 108 techniques, and conventional drilling 110.

MPD techniques can be based on applying surface backpressure using choke or other surface equipment. The choke or other surface equipment can provide mechanisms that translate into downhole pressure and prevent influx. The surface backpressure values can be used to achieve desired downhole bottomhole pressure and to maintain downhole bottomhole pressure at constant levels throughout drilling operations. This capability cannot be provided using conventional technologies depending on factors that are not measured in real-time, such as drilling fluid density or rheology. The present disclosure describes techniques that are based, at least in part, on real-time mud property monitoring systems. The techniques include using an algorithm for real-time surface backpressure calculations, from which accurate real-time control of drilling operations is provided.

SBP values can be determined and used during different connection times than those applied during drilling operations, such as when pumps are turned on. This is because flow hydraulics can induce frictional losses along the wellbore, which can result in pressure losses. Pressure losses can lead to an additional pressure exerted downhole. To help solve this problem, equivalent circulating density (ECD) techniques can be used. ECD can represent the combination of mud density and the resulting annular pressure losses during drilling operations. SBP can be used in MPD operations to maintain constant bottomhole pressure within a range defined by a fracture pressure (for example, fracture gradient 112) and a pore pressure 114. A bore hole stability line 116 is also indicated on FIG. 1.

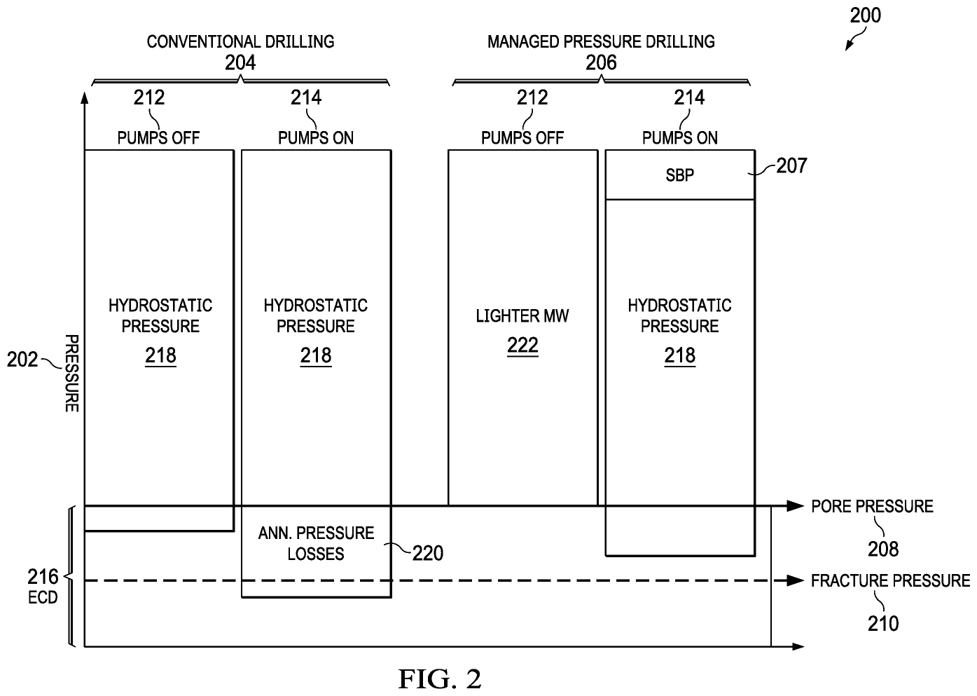

FIG. 2 is a bar chart 200 showing examples of differences between pressures 202 attained in conventional drilling 204 versus managed pressure drilling 206, according to some implementations of the present disclosure. For example, SBP techniques 207 can be used in MPD operations to maintain the resultant bottomhole pressure within a pore pressure 208 and a fracture pressure 210 window throughout the drilling operation. The drilling operation can include a pumps-off phase 212 and a pumps-on phase 214. The bar chart 200 indicates hydrostatic pressure 218 values for the pumps-off phase 212 and the pumps-on phase 214.

The present disclosure includes an algorithm that is able to calculate the ECD 216 of the mud using real-time data of fluid properties such as density and rheology. The resulting ECD values can then be used to automatically calculate SBP values in real time. Use of the algorithm can increase safety, reduce cost, and reduce risk. Drilling operational parameters, including fluid properties, can be obtained in real-time from surface or downhole rig sensors. The drilling operational parameters can then be sent to a computer that uses an application to calculate pressure loss using hydraulic models, and then calculates SBP in real time. The calculated values can then be sent to rig operators for quick decision-making and pressure control. Information generated from the models can be used to advise an end user, for example, to reduce the back pressure value by certain amount, to increase the back pressure, or to take other actions (for example, opening or closing a valve).

In data gathering processes, for example, application code can receive and use real-time data of fluid density, drilling operational parameters, and rheology through devices installed on site or downhole. The devices can include, for example, densometers and viscometers. The real-time data can include the results of frequent measurements in real time. Application code can transfer the data to a database to ensure data accuracy. Programmed models and algorithms can then use the accurate data from the database for calculations.

In processes involving the use of modeling techniques, for example, pressure loss calculations can be performed to obtain real-time measurements of ECD. Different techniques and hydraulic models can be used, including American Petroleum Institute (API) models, Herschel Bulkley models, and Power Law models. Application code can use one or more of the hydraulic models to perform hydraulic calculations and to output annular pressure losses (APL) 220. The APL 220 can then be used to calculate SBP in real time for use in MPD drilling operations. The bar chart 200 indicates a lighter mud weight (MW) 222.

As an example, conventional drilling operations can use the following to determine bottom hole pressure (BHP):

BHP=P_{hydro}+APL (1)

where P_{hydro} is a hydrostatic pressure. By comparison, MPD drilling operations can use the following to determine BHP:

BHP=P_{hydro}+APL+SBP (2)

During data preprocessing processes, for example, application code can be used to obtain real-time drilling data captured on a rig site from sensors. The application code can transform the data from analog or digital format into wellsite information transfer standard markup language (WITSML) format. Data in WITSML format can be sent, for example, by satellite to a drilling company's headquarters for database storage. Such data preprocessing processes can be very frequent and fast. For example, it may require only 3-5 seconds for a data point to be captured from a rig site and stored in the database. On the central database, a set of artificial intelligent (AI) models can be used when processing the data to convert raw data points to decision-making information.

Application code can store both raw and processed data in the database. The data can be used to provide drilling engineers and foreman with support tools and interfaces, for example, that can display information as continuous curves that show data relationships over time. The information provided to the drilling engineers and foreman can provide a capability for monitoring current well behavior and tracking a historical development of the well behavior. Data and displays provided to the user can present both time-based and depth-based information.

In some implementations, the following sample code can be used to obtain real-time information and obtain SBP:
# this is the starting point
# clear the workspace
cat (“\014”)
rm(list=ls( )
print (‘START . . . ’)
# set the directory
work_directory_path<-
   ‘D:\\Users\\gharsh0a\\Documents\\Projects\\2018\\Aljubran_SBP\\CODE\\v11’
setwd(work_directory_path)
source(‘prep.R’)
# set Credentials
cr<-list( )
cr$USERNAME<-‘GHARSH0A’
scale_x_reverse(breaks=RheologyLog$INDEX[lable_breaks], labels=SurfaceLog$INDEX[lable_breaks])+
xlab(“ ”)+ylab(“ECD, MW”)+
grid.newpage( )
grid.draw(cbind(ggplotGrob(SPP_Plot), ggplotGrob(BHCP_Plot), ggplotGrob(SBP_Plot), ggplotGrob(ECD_Plot), size=“last”))
png_file_name<-paste(‘plot_’, gsub(“.csv”, “.png”, final_result_fileName))
dev.copy(png,filename=png_file_name,width=8000,height=10000, res=600);
dev.off( );
head(RheologyLog)
}# end function write_to_file

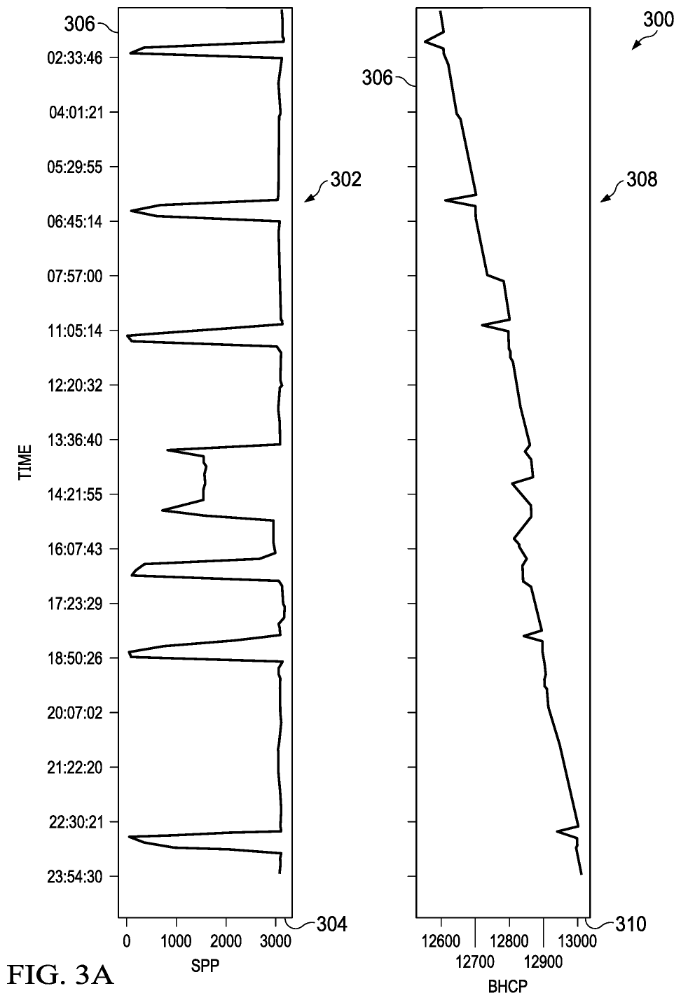

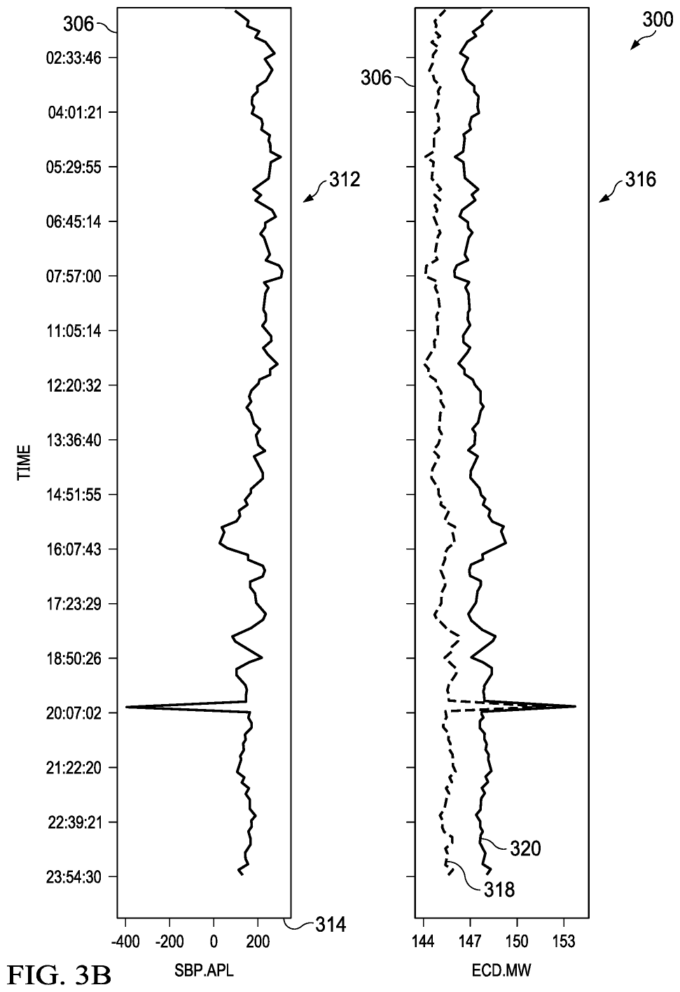

FIGS. 3A-3B include graphs 300 showing examples of output of an algorithm that automates SBP based on an actual ECD and a desired bottomhole pressure, according to some implementations of the present disclosure. For example, the graphs 300 can be generated based on executing the described sample code. The graphs 300 can illustrate SBP values calculated from real-time hydraulics based on the desired bottomhole pressure.

A standpipe pressure (SPP) graph 302 is a graph that plots an SPP 304 relative to a time 306 and indicates a total pressure loss over time. A bottom hole circulating pressure (BHCP) graph 308 is a graph that plots a BHCP 310 relative to the time 306. An SBP+APL graph 312 is a graph that plots an SBP and APL sum 314 relative to the time 306. An ECD and MW graph 316 plots an ECD 318 and an MW 320 relative to the time 306.

In some implementations, graphs and information similar to the information presented in FIGS. 3A-3B can be presented to drilling engineers and foremen. The information can be presented in one or more user interfaces (UIs) and can be continuously updated using real-time information. The UIs can provide UI controls by which users (for example, drilling engineers and foremen) can select new parameters or confirm suggested parameters. For example, the suggested parameters can include parameters and values that are suggested based on real-time information and calculations. In some implementations, SBP values calculated from real-time hydraulics can be applied automatically, for example, without user intervention.

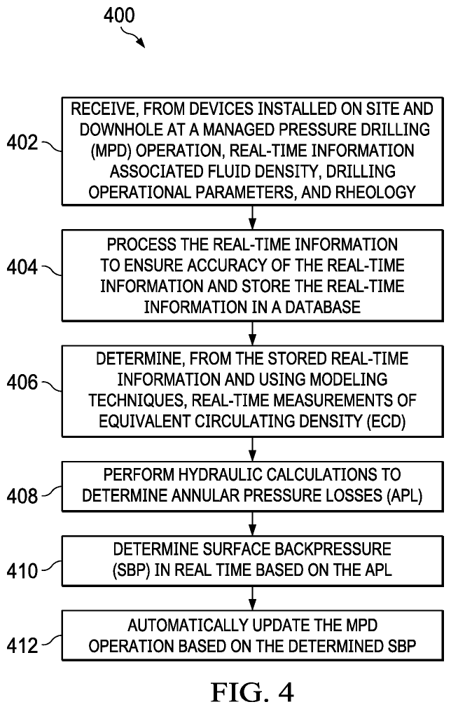

FIG. 4 is a flowchart of an example method 400 for updating MPD operations based on real-time values determined for surface backpressure (SBP), according to some implementations of the present disclosure. For clarity of presentation, the following description generally describes method 400 in the context of the other figures in this description. However, it will be understood that method 400 may be performed, for example, by any suitable system, environment, software, and hardware, or a combination of systems, environments, software, and hardware, as appropriate. In some implementations, various steps of method 400 can be run in parallel, in combination, in loops, or in any order.

At 402, real-time information associated with fluid density, drilling operational parameters, and rheology is received from devices installed on site and downhole at a managed pressure drilling (MPD) operation. The devices that capture and provide the real-time information can include, for example, densometers and viscometers. The managed pressure drilling (MPD) operation can be an oil drilling operation, for example. From 402, method 400 proceeds to 404.

At 404, the real-time information is processed to ensure accuracy of the real-time information and the real-time information is stored in a database. As an example, the real-time information received from the MPD can be processed at a central facility using central databases to store the information. Computers at the central facility can analyze the real-time information to ensure that the real-time information is accurate. From 404, method 400 proceeds to 406.

At 406, real-time measurements of equivalent circulating density (ECD) are determined from the stored real-time information and using modeling techniques. For example, the modeling techniques can include pressure loss calculations and can include hydraulic models including one or more of American Petroleum Institute (API) models, Herschel Bulkley models, and Power Law models. From 406, method 400 proceeds to 408.

At 408, hydraulic calculations are performed to determine annular pressure losses (APL). For example, computers can use algorithms and code similar to the example provided to compute APL values from the stored information, including ECD values. From 408, method 400 proceeds to 410.

At 410, surface backpressure (SBP) is determined in real time based on the APL. As an example, computers can use algorithms and code similar to the example provided to compute SBP using the APL values. From 410, method 400 proceeds to 412.

At 412, the MPD operation is automatically updated based on the determined SBP. For example, automatic and semi-automatic actions can occur at the MPD operation using the determined SBP. For example, the pressure of a back pressure valve of the MPD can be reduced or increased, or a particular valve can be opened or closed. After 412, method 400 stops.

In some implementations, method 400 further includes using a user interface for providing information to users and receiving input from the users. For example, suggestions for MPD operation settings and graphical information can be provided for presentation to a user in the user interface. The suggestions can include, for example, a suggestion to reduce or increase a back pressure valve of the MPD by a suggested amount. In another example, the suggestions can include a suggestion to open or close a suggested valve of the MPD operation. The graphical information can include, for example, graphs presenting an automated SBP based on the actual ECD and a desired bottomhole pressure for the MPD operation. In some implementations, the graphical information can include graphs similar to the graphs described with reference to FIGS. 3A-3B User inputs, provided by the user based on the suggestions, can be received. The MPD operation can be updated based on the user inputs.

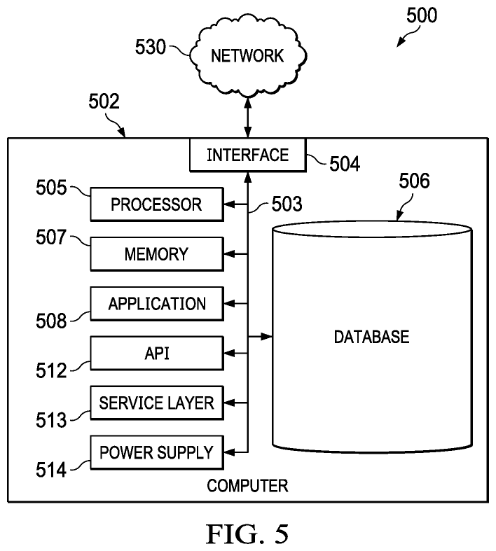

FIG. 5 is a block diagram of an example computer system 500 used to provide computational functionalities associated with described algorithms, methods, functions, processes, flows, and procedures, as described in the instant disclosure, according to some implementations of the present disclosure. The illustrated computer 502 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 502 can include a computer that includes an input device, such as a keypad, keyboard, a touch screen that can accept user information, and an output device that conveys information associated with the operation of the computer 502, including digital data, visual, or audio information (or a combination of information), or a graphical-type user interface (UI) (or GUI).

The computer 502 can serve in a role as a client, network component, a server, a database, a persistency, or components of a computer system for performing the subject matter described in the instant disclosure. The illustrated computer 502 is communicably coupled with a network 530. In some implementations, one or more components of the computer 502 may be configured to operate within environments, including cloud-computing-based, local, global, and a combination of environments.

Generally, the computer 502 is an electronic computing device operable to receive, transmit, process, store, or manage data and information associated with the described subject matter. According to some implementations, the computer 502 may also include or be communicably coupled with an application server, email server, web server, caching server, streaming data server, or a combination of servers.

The computer 502 can receive requests over network 530 from a client application (for example, executing on another computer 502) and respond to the received requests by processing the received requests using an appropriate software application(s). In addition, requests may also be sent to the computer 502 from internal users, access methods, external or third-parties, automated applications, entities, individuals, systems, or computers.

Each of the components of the computer 502 can communicate using a system bus 503. In some implementations, any or all of the components of the computer 502, hardware or software (or a combination of both hardware and software), may interface with each other or the interface 504 (or a combination of both), over the system bus 503 using an application programming interface (API) 512 or a service layer 513 (or a combination of the API 512 and service layer 513). The API 512 may include specifications for routines, data structures, and object classes. The API 512 may be either computer-language independent or dependent and refer to a complete interface, a single function, or even a set of APIs. The service layer 513 provides software services to the computer 502 and other components (whether or not illustrated) that are communicably coupled to the computer 502. The functionality of the computer 502 may be accessible for all service consumers using this service layer. Software services, such as those provided by the service layer 513, provide reusable, defined functionalities through a defined interface. For example, the interface may be software written in JAVA, C++, or a language providing data in extensible markup language (XML) format. While illustrated as an integrated component of the computer 502, alternative implementations may illustrate the API 512 or the service layer 513 as stand-alone components in relation to other components of the computer 502 and other components communicably coupled to the computer 502. Moreover, any or all parts of the API 512 or the service layer 513 may be implemented as children or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems which are connected to the network 530 (whether illustrated or not) in a distributed environment. Generally, the interface 504 includes logic encoded in software or hardware (or a combination of software and hardware) and is operable to communicate with the network 530. More specifically, the interface 504 may include software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors may be used according to particular needs, desires, or particular implementations of the computer 502. Generally, the processor 505 executes instructions and manipulates data to perform the operations of the computer 502 and any algorithms, methods, functions, processes, flows, and procedures as described in the instant disclosure.

The computer 502 also includes a database 506 which can hold data for the computer 502 and other components connected to the network 530 (whether illustrated or not). For example, database 506 can be an in-memory, conventional, or a database storing data consistent with this disclosure. In some implementations, database 506 can be a combination of two or more different database types (for example, a hybrid in-memory and conventional database) according to particular needs, desires, or particular implementations of the computer 502 and the described functionality. Although illustrated as a single database 506 in FIG. 5, two or more databases (of the same or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 which can hold data for the computer 502 or a combination of components connected to the network 530 (whether illustrated or not). Memory 507 can store any data consistent with this disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 is an algorithmic software engine providing functionality according to particular needs, desires, or particular implementations of the computer 502, particularly with respect to the functionality described in this disclosure. For example, application 508 can serve as one or more components, modules, or applications. Further, although illustrated as a single application 508, the application 508 may be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery which can be configured to be either user- or non-user-replaceable. In some implementations, the power supply 514 can include power-conversion or management circuits (including recharging, standby, or a power management functionality). In some implementations, the power-supply 514 can include a power plug to allow the computer 502 to be plugged into a wall socket or a power source to, for example, power the computer 502 or recharge a rechargeable battery.

There may be any number of computers 502 associated with, or external to, a computer system containing computer 502, each computer 502 communicating over network 530. Further, the term “client,” “user,” and other appropriate terminology may be used interchangeably, as appropriate, without departing from the scope of this disclosure. Moreover, this disclosure contemplates that many users may use one computer 502, or that one user may use multiple computers 502.

Described implementations of the subject matter can include one or more features, alone or in combination.

For example, in a first implementation, a computer-implemented method includes the following. Real-time information associated with fluid density, drilling operational parameters, and rheology is received from devices installed on site and downhole at a managed pressure drilling (MPD) operation. The real-time information is processed to ensure accuracy of the real-time information, and the real-time information is stored in a database. Real-time measurements of equivalent circulating density (ECD) are determined from the stored real-time information using modeling techniques. Hydraulic calculations are performed to determine annular pressure losses (APL). Surface backpressure (SBP) is determined in real time based on the APL. The MPD operation is automatically updated based on the determined SBP.

The foregoing and other described implementations can each, optionally, include one or more of the following features:

A first feature, combinable with any of the following features, where the devices include densometers and viscometers.

A second feature, combinable with any of the previous or following features, where the modeling techniques include pressure loss calculations.

A third feature, combinable with any of the previous or following features, where the modeling techniques use hydraulic models including one or more of American Petroleum Institute (API) models, Herschel Bulkley models, and Power Law models.

A fourth feature, combinable with any of the previous or following features, where automatically updating the MPD drilling operation includes using the SBP to maintain a constant bottomhole pressure within a fracture pressure and a pore pressure window.

A fifth feature, combinable with any of the previous or following features, the method further including: providing, for presentation to a user in a user interface, suggestions for MPD operation settings and graphical information including graphs presenting an automated SBP based on the actual ECD and a desired bottomhole pressure for the MPD operation; receiving user inputs provided by the user based on the suggestions; and updating the MPD operation based on the user inputs.

A sixth feature, combinable with any of the previous or following features, where the suggestions include a suggestion to reduce or increase a back pressure valve of the MPD by a suggested amount.

A seventh feature, combinable with any of the previous or following features, where the suggestions include a suggestion to open or close a suggested valve of the MPD operation.

In a second implementation, a non-transitory, computer-readable medium storing one or more instructions executable by a computer system to perform operations including the following. Real-time information associated with fluid density, drilling operational parameters, and rheology is received from devices installed on site and downhole at a managed pressure drilling (MPD) operation. The real-time information is processed to ensure accuracy of the real-time information, and the real-time information is stored in a database. Real-time measurements of equivalent circulating density (ECD) are determined from the stored real-time information using modeling techniques. Hydraulic calculations are performed to determine annular pressure losses (APL). Surface backpressure (SBP) is determined in real time based on the APL. The MPD operation is automatically updated based on the determined SBP.

The foregoing and other described implementations can each, optionally, include one or more of the following features:

A first feature, combinable with any of the following features, where the devices include densometers and viscometers.

A second feature, combinable with any of the previous or following features, where the modeling techniques include pressure loss calculations.

A third feature, combinable with any of the previous or following features, where the modeling techniques use hydraulic models including one or more of American Petroleum Institute (API) models, Herschel Bulkley models, and Power Law models.

A fourth feature, combinable with any of the previous or following features, where automatically updating the MPD drilling operation includes using the SBP to maintain a constant bottomhole pressure within a fracture pressure and a pore pressure window.

A fifth feature, combinable with any of the previous or following features, the operations further including: providing, for presentation to a user in a user interface, suggestions for MPD operation settings and graphical information including graphs presenting an automated SBP based on the actual ECD and a desired bottomhole pressure for the MPD operation; receiving user inputs provided by the user based on the suggestions; and updating the MPD operation based on the user inputs.

A sixth feature, combinable with any of the previous or following features, where the suggestions include a suggestion to reduce or increase a back pressure valve of the MPD by a suggested amount.

A seventh feature, combinable with any of the previous or following features, where the suggestions include a suggestion to open or close a suggested valve of the MPD operation.

In a third implementation, a computer-implemented system, including one or more processors and a non-transitory computer-readable storage medium coupled to the one or more processors and storing programming instructions for execution by the one or more processors, the programming instructions instructing the one or more processors to perform operations including the following. Real-time information associated with fluid density, drilling operational parameters, and rheology is received from devices installed on site and downhole at a managed pressure drilling (MPD) operation. The real-time information is processed to ensure accuracy of the real-time information, and the real-time information is stored in a database. Real-time measurements of equivalent circulating density (ECD) are determined from the stored real-time information using modeling techniques. Hydraulic calculations are performed to determine annular pressure losses (APL). Surface backpressure (SBP) is determined in real time based on the APL. The MPD operation is automatically updated based on the determined SBP.

The foregoing and other described implementations can each, optionally, include one or more of the following features:

A first feature, combinable with any of the following features, where the devices include densometers and viscometers.

A second feature, combinable with any of the previous or following features, where the modeling techniques include pressure loss calculations.

A third feature, combinable with any of the previous or following features, where the modeling techniques use hydraulic models including one or more of American Petroleum Institute (API) models, Herschel Bulkley models, and Power Law models.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include, special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code constituting processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or a unit for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules implementing the various features and functionality through various objects, methods, or processes, the programs may instead include a number of sub-modules, third-party services, components, libraries, and such, as appropriate. Conversely, the features and functionality of various components can be combined into single components, as appropriate. Thresholds used to make computational determinations can be statically determined, dynamically determined, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/−R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light-emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with some implementations of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 protocols), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or a combination of communication types between network addresses.

The computing system can include clients and servers. A client and server are generally remote from each other and typically interact through a communication network. The relationship of client and server arises by virtue of computer programs running on the respective computers and having a client-server relationship to each other.

Cluster file systems can be any file system type accessible from multiple servers for read and update. Locking or consistency tracking may not be necessary since the locking of exchange file system can be done at application layer. Furthermore, Unicode data files are different from non-Unicode data files.

While this specification contains many specific implementation details, these should not be construed as limitations on the scope of what may be claimed, but rather as descriptions of features that may be specific to particular implementations. Certain features described in this specification in the context of separate implementations can also be implemented, in combination, in a single implementation. Conversely, various features described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving, from devices installed on site and downhole at a managed pressure drilling (MPD) operation, real-time information associated with fluid density, drilling operational parameters, and rheology;
processing the real-time information to ensure accuracy of the real-time information and storing the real-time information in a database;
determining, from the stored real-time information and using modeling techniques, real-time measurements of equivalent circulating density (ECD);
performing hydraulic calculations to determine annular pressure losses (APL);
determining surface backpressure (SBP) in real time based on the APL; and
automatically updating the MPD operation based on the determined SBP.

2. The computer-implemented method of claim 1, wherein the devices include densometers and viscometers.

3. The computer-implemented method of claim 1, wherein the modeling techniques include pressure loss calculations.

4. The computer-implemented method of claim 1, wherein the modeling techniques use hydraulic models including one or more of American Petroleum Institute (API) models, Herschel Bulkley models, and Power Law models.

5. The computer-implemented method of claim 1, wherein automatically updating the MPD drilling operation includes using the SBP to maintain a constant bottomhole pressure within a fracture pressure and a pore pressure window.

6. The computer-implemented method of claim 1, further comprising:
providing, for presentation to a user in a user interface, suggestions for MPD operation settings and graphical information including graphs presenting an automated SBP based on the actual ECD and a desired bottomhole pressure for the MPD operation;
receiving user inputs provided by the user based on the suggestions; and
updating the MPD operation based on the user inputs.

7. The computer-implemented method of claim 1, wherein the suggestions include a suggestion to reduce or increase a back pressure valve of the MPD by a suggested amount.

8. The computer-implemented method of claim 1, wherein the suggestions include a suggestion to open or close a suggested valve of the MPD operation.

9. A non-transitory, computer-readable medium storing one or more instructions executable by a computer system to perform operations comprising:
receiving, from devices installed on site and downhole at a managed pressure drilling (MPD) operation, real-time information associated with fluid density, drilling operational parameters, and rheology;
processing the real-time information to ensure accuracy of the real-time information and storing the real-time information in a database;
determining, from the stored real-time information and using modeling techniques, real-time measurements of equivalent circulating density (ECD);
performing hydraulic calculations to determine annular pressure losses (APL);
determining surface backpressure (SBP) in real time based on the APL; and
automatically updating the MPD operation based on the determined SBP.

10. The non-transitory, computer-readable medium of claim 9, wherein the devices include densometers and viscometers.

11. The non-transitory, computer-readable medium of claim 9, wherein the modeling techniques include pressure loss calculations.

12. The non-transitory, computer-readable medium of claim 9, wherein the modeling techniques use hydraulic models including one or more of American Petroleum Institute (API) models, Herschel Bulkley models, and Power Law models.

13. The non-transitory, computer-readable medium of claim 9, wherein automatically updating the MPD drilling operation includes using the SBP to maintain a constant bottomhole pressure within a fracture pressure and a pore pressure window.

14. The non-transitory, computer-readable medium of claim 9, the operations further comprising:
providing, for presentation to a user in a user interface, suggestions for MPD operation settings and graphical information including graphs presenting an automated SBP based on the actual ECD and a desired bottomhole pressure for the MPD operation;
receiving user inputs provided by the user based on the suggestions; and
updating the MPD operation based on the user inputs.

15. The non-transitory, computer-readable medium of claim 9, wherein the suggestions include a suggestion to reduce or increase a back pressure valve of the MPD by a suggested amount.

16. The non-transitory, computer-readable medium of claim 9, wherein the suggestions include a suggestion to open or close a suggested valve of the MPD operation.

17. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving, from devices installed on site and downhole at a managed pressure drilling (MPD) operation, real-time information associated with fluid density, drilling operational parameters, and rheology;
processing the real-time information to ensure accuracy of the real-time information and storing the real-time information in a database;
determining, from the stored real-time information and using modeling techniques, real-time measurements of equivalent circulating density (ECD);
performing hydraulic calculations to determine annular pressure losses (APL);
determining surface backpressure (SBP) in real time based on the APL; and
automatically updating the MPD operation based on the determined SBP.

18. The computer-implemented system of claim 17, wherein the devices include densometers and viscometers.

19. The computer-implemented system of claim 17, wherein the modeling techniques include pressure loss calculations.

20. The computer-implemented system of claim 17, wherein the modeling techniques use hydraulic models including one or more of American Petroleum Institute (API) models, Herschel Bulkley models, and Power Law models.
